(19) United States
(12) Patent Application Publication
(10) Pub. No.: US 2009/0291172 A1
(43) Pub. Date: Nov. 26, 2009

(54) Apparatus and method for creation of beverages

(76) Inventor: Lazaro Jorge Saez, Miami, FL (US)

Correspondence Address: Lazaro Jorge Saez, 2910 SW 105 Ave., Miami, FL, 33165, US

(21) Appl. No.: 12/454,307

(22) Filed: May 18, 2009

Related U.S. Application Data
(60) Provisional application No. 61/054,760, filed on May 20, 2008.

(51) Int. Cl. A23L 2/00

(52) U.S. Cl. 426/330.5

(57) ABSTRACT

In one embodiment, a method for flavoring drinks with coconut flavor in the very coconut shell as a container without using any preservative while conserving in a good condition the drinks and the flesh in coconut for an extended period of time comprising the steps of (i) providing a ripened, peeled coconut shell (12); (ii) drilling a hole (14) on top of the coconut shell; (iii) fitting a hollowed plug (20) which includes means to be fasten in hole (14); (iv) refilling coconut with a beverage until an overflow of the ripe coconut shell (12; (v) placing the coconut shell (12) on a base (30) which includes means for fastening the coconut shell onto the base thereby converting the shell (12) into flavoring-fruit-container (10) and enabling delivery of coconut-flavored drinks; (vi) keeping the beverage bottled in the flavoring-fruit-container (10) for a predetermined period of time, preferably at least a period of thirty days to permit the coconut flesh to interact with the liquid previously poured into the coconut shell.

### CROSS-REFERENCE TO RELATED APPLICATIONS

This application claims the benefit of provisional patent application Ser. No. 61/054,760 Filed 2008, May 20 by the present inventor

### FEDERALLY SPONSORED RESEARCH

N/A

### SEQUENCE LISTING OR PROGRAM

N/A

### BACKGROUND FIELD OF THE INVENTION

The present invention relates to an apparatus and method used to create beverages, particularly flavored beverages. The present invention also relates to the creation of beverages utilizing fruits having a hard shell such as a coconut.

### BACKGROUND DESCRIPTION OF PRIOR ART

Commonly known beverage manufacturing techniques involve the extraction of fruit nectars to make syrups or concentrates, these nectars are later mixed which water, preservatives, and other artificial sweeteners to process the beverage. Thereupon, the beverage is bottled or placed into various containers for distribution and sale. These prior techniques typically require the use of some preservative to conserve the natural fruit nectars. There is a need for an apparatus and method that would produce mixed beverages that can utilize the fruit nectar in its natural state.

Others have described devices that allow a person to consume certain fruits in their natural state. For example, U.S. Pat. No. 5,119,559 to Sanabria discloses a coconut opener for removing a section of the skin and shell of a coconut. Others describe beverage containers. U.S. Pat. No. 4,883,192 to Krugman discloses a bifunctional, reusable beverage container closure for sealing an opened metal container for carbonated liquids. U.S. Pat. No. 2,746,379 to Covigton discloses a juice extractor for citrus fruits. And U.S. Pat. No. 4,889,044 to Rosenfield discloses a juice extractor and straw for citrus fruits. However, none of the above-cited prior art discloses the apparatus and method of the present invention.

### SUMMARY OF THE INVENTION

In accordance with the present invention a method for flavoring drinks with fruit. In one preferred embodiment, the method provides for the creation of a beverage having a coconut flavor. The method of creating a beverage utilizing a fruit-shell includes, the providing of a ripe coconut shell, the insertion of a plug having an inner conduit into the shell; draining fluid from the coconut shell, inserting a beverage into the shell and placing a cap onto the plug. The apparatus includes a plug having an inner conduit or bore, a removable cap, a sealing means to attach the plug to the shell and may include a base to stabilize the shell when placed on a surface. The embodiment may also include means to fasten the plug and the base to the coconut shell. One such means includes glue or other.

### OBJECTS AND ADVANTAGES

The following section of the written description describes some of the objects of the present invention, but the section is not exhaustive of all of invention's objects.

Accordingly, it is one of the main objects of the present invention to provide a method to manufacture flavored beverages and drinks without using any preservative or chemical substance during the process of produce such drinks.

Another object and advantage of this invention is to provide a method which facilitates see turning a ripe coconut shell into a flavoring-fruit-container for bottle and delivery flavored beverages.

It is yet a further objection to provide a method of transferring the natural flavor of the fruit via its shell to the liquid contained in it.

It is a further object of the present invention to provide a means and method to make a beverage within the shell of a coconut such that the flesh within the coconut provides flavoring to the liquid placed in the interior of the shell.

Another object of the present invention is to provide a method which enables the refilling of a ripe coconut shell with a beverage that is preserved along with the flesh in the coconut shell.

It is yet a further object to provide a method for flavoring a beverage which is simple to execute and inexpensive to manufacture.

Still further objects and advantages will become apparent from a consideration of the ensuing description and drawings.

### BRIEF DESCRIPTION OF THE DRAWINGS

The foregoing, and other objects, features, and advantages of the present invention are shown and described in the following detailed description of the preferred embodiments which should be viewed in conjunction with the accompanying drawings in which:

FIG. 1 is an isometric view of one embodiment of the flavoring-fruit-container of the present invention;

FIG. 1A is a cross-sectional view of one embodiment of a particularly shaped plug, a ripe coconut shell including a hole on top, and a base particularly shaped for practicing the method of the present invention;

FIG. 1B is an isometric view of the plug shown in F 1; and

FIG. 1C is an isometric view of a ripe coconut shell including a hole on top.

### REFERENCE NUMERALS IN DRAWINGS

| | |
|---|---|
| 10 | flavoring fruit container |
| 12 | ripe coconut shell |
| 14 | hole |
| 15 | drink |
| 16 | flesh |
| 18 | polished surface |
| 19 | gasket |
| 20 | plug |
| 21 | mesh |
| 23 | lower end |
| 25 | spout end |
| 26 | removable cap |
| 27 | inner conduit |
| 28 | flap section |
| 30 | base |
| 32 | conic section |
| 35 | legs |

### DETAILED DESCRIPTION OF THE PREFERRED EMBODIMENTS

The present invention 10 provides a process and method for flavoring drinks with the flavor of the fruit whose shell is used as the holding container. In particular, the illustrated embodiment relates to a shell of a coconut 12 used to provide flavor to the beverage. In this embodiment, there is no preservative required. It is important to note that the embodiments of the invention described below are only examples of some of the uses of the teachings described herein. In general, statements made in the specification do not limit any of the various claimed inventions. Moreover, some statements may apply to some inventive features but no to others. Unless otherwise indicated, singular elements may be in the plural and vice versa with no loss of generality. Similar reference numerals and letters represent similar components and system features throughout the drawings and the written description.

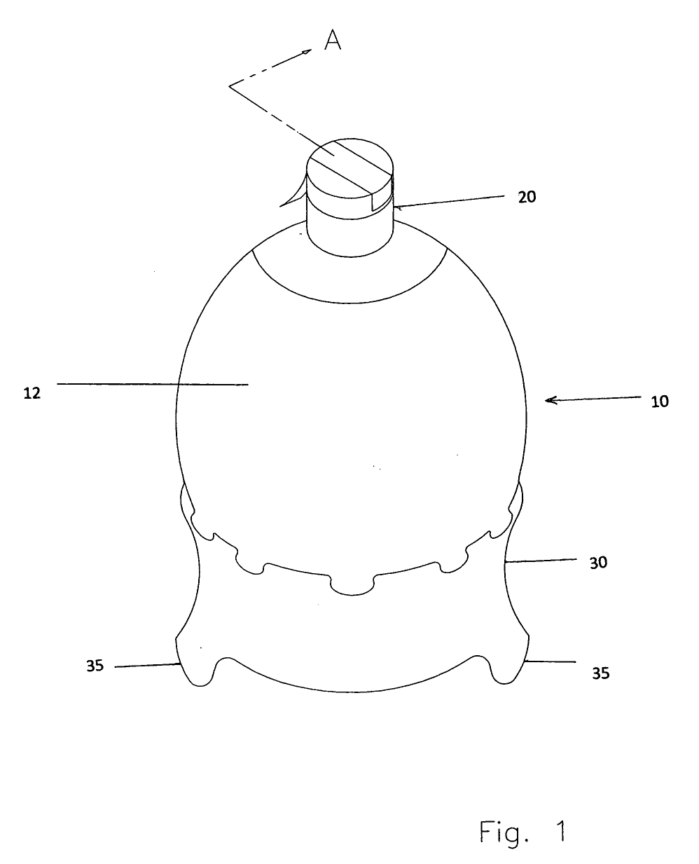

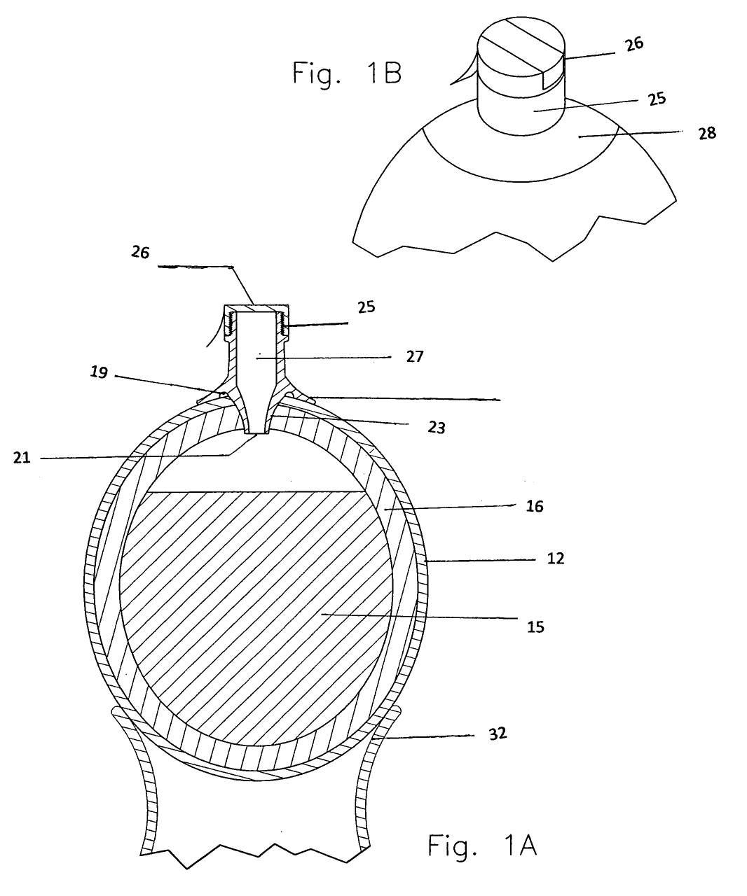

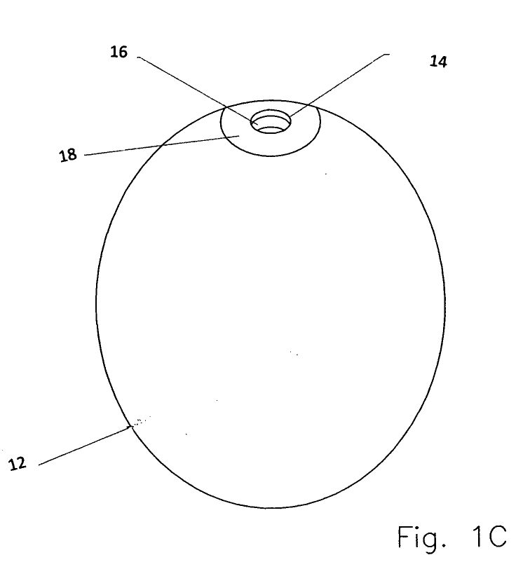

In the illustrated embodiments, the beverage 15 is bottled in a ripe coconut shell 12 used as a container. The ripened coconut 12 is peeled so that only the inner shell 12 remains. The method of using the fruit shell is illustrated in FIG. 1, 1A, 1B and 1C, comprises the following steps:

Providing a sealed, i.e., non-leaking, ripe coconut 12 as had shown in FIG. 1C. The outer shell of the coconut 12 has been removed.

Next, drilling a hole 14 trough the inner shell and flesh 16 on top of the ripe coconut 12.

Polishing the rough outer surface 18 around the hole 14 on shell 12 as shown FIG. 1C.

Providing a generally, cylindrical plug 20 which, in the illustrated, exemplary embodiment, includes:
A hollow, generally cylindrical body.
1. An externally threaded cylindrical spout end 25 having an internally threaded removable screw cap 26 operatively disposed on top to form a substantially hermetic seal with the spout end 25 as shown in FIG. 1A.
2. An cylindrical lower end 23 for firmly fitting in hole 14 on top of shell 12 to form a substantially hermetic seal with the flavoring-fruit-container 10 FIG. 1
3. An inner conduit or bore 27 extending from spout end 25 all the way to lower end 23 for filling and emptying out the beverage contained within the coconut. The inner conduit 27 may also include a mesh 21 to prevent solid residue from flesh 16 coming out when pouring the drink.
4. A circular flap section 28 extending out from the plug 20. Flap section 28 consists of a flexible sheet to lodge or affix the plug 20 to the top of coconut shell 12.

Another step in the method includes providing sealing means 19 to seal the bottom of flap section 28 to the top of the shell 12. The sealing means can be a gasket made of a flexible material such as plastic, rubber, silicone or wax. In one embodiment, the sealing means 19 has a ring-shaped cross-section. The purpose of the sealing means 19 is preventing leakage of liquid out from the interior of the coconut.

The coconut is filled with a beverage 15 so that the entire coconut is filled, leaving little or no volume of space with air. The lack of air at the top of the coconut will help in the preservation of the beverage as there will remain little, if any, oxygen for oxidation.

The present invention and method also include a base 30 to stabilize the container. The base includes a conically shaped section 32 for fittingly receiving the bottom of the ripe coconut 12 or other fruit shell. The base may include a plurality of legs 35 for setting the entire flavoring-fruit-container 10 on a table or other flat surface.

The system of the present invention is easy to construct. The ring-shaped gasket 19 is placed on the polished surface 18 around hole 14 on top of the ripe coconut 12. The generally cylindrical plug 20 is fitted into hole 14 in such a way that the flap section 28 overlaps the outer shell such that the ring-shaped gasket 19 is squeezed between the interior portion of the plug 20 and the outer surface of the coconut 12. The bottom of the coconut, the side that is 180 degrees from the plug, is placed within the conic section 32 of the base 30. In one embodiment, the plug section and the base section can be fastened together by using a appropriate glue so that the ripe coconut 12 will be tightly fastened between the base 30 and the flap section 28 for turning out the ripe coconut 12 into a sealed tamper-proof flavoring-fruit-container 10 as shown in FIG. 1 for packing and delivery coconut flavored drinks.

The container 10 is then filled to capacity, even allowing some overflow, such that the liquid displaces all of the air-oxygen. This will prolong the preservation time of the liquid in the container will help prevent fermentation of the flesh 16 and eventually decomposition of the drinks in the flavoring-fruit-container 10.

This liquid beverage bottled in the flavoring-fruit-container 10 should be kept for a period of several days, and preferably thirty days or more, to permit the flesh 16 of the coconut to act as a flavoring for transferring the coconut flavor to the beverage.

FIG. 1 illustrates an alternative design for the beverage container having a unique ornamental aspect.

The foregoing disclosure and drawing are merely illustrative of the principles of this invention and are no to be interpreted in a limiting sense. I wish to be understood that I do not desire to be limited to the exact detail of construction shown and described for obvious modifications will occur to a person skilled in the arL The invention should be limited only by the scope of the appended claim.

What I claim is:

1. A method to create flavored beverages including the use of a ripe fruit-shell as a container and conserving in a good condition the drinks and the flesh in the fruit-shell for an extended period of time, comprise:
a. providing a ripe hard shell fruit
b. opening a hole through out of the shell and flesh of the fruit-shell,
c. providing a plug which fit in the hole, the plug including:
d. a hollow generally cylindrical body,
e. an spout end having screw able cap,
f. a lower end and means for firmly fit in the hole on the fruit-shell,
g. an inner conduit extended from the spout end all the way to the lower end, having a mesh,
h. means for fastening the plug to the ripe fruit-shell,
i. providing sealing means, between said lower end and the ripe fruit-shell,
j. providing a base on which leans the fruit-shell. The base including:
k. a section for fitly receiving the bottom of the fruit-shell,
l. means for fastening the fruit-shell to the base,
m. a plurality of legs to set on a table or on a surface,
n. fitting the plug in the hole of the fruit-shell,
o. placing the bottom of the fruit-shell on the receiving section of the base,
p. fastening the fruit-shell firmly between the base and the plug turning the fruit-shell into a flavoring-fruit-container enable for bottle and delivery flavored drinks,
q. refilling up to over flow the flavoring-fruit-container with some drinks in a way that the liquid causing all of the air-oxygen getting out of the flavoring-fruit-container preventing fermentation of the flesh and eventually decomposition of the drinks.
r. Keeping the drinks bottled in the flavoring-fruit-container during a necessary period of time permitting the flesh acting as a flavoring and transferring the fruit flavor from the fruit flesh to the drinks in the flavoring-fruit-container,
WHEREBY the flesh of the fruit will flavor the drinks without using any preservative or chemical substance while conserving in a good condition the drinks and the flesh in the fruit-shell for an extended period of time, and;
WHEREBY the fruit-shell including both, the plug fitted in the hole and the base at the bottom, will turn into a sealed tamper-proof flavoring-fruit-container enable for bottle and delivery flavored drinks.
